(19) United States
(12) Patent Application Publication
(10) Pub. No.: US 2013/0119790 A1
(43) Pub. Date: May 16, 2013

(54) ELECTRIC MOTOR

(71) Applicant: Johnson Electric S.A., Murten (CH)

(72) Inventors: Jin Yan Gan, Shatin (HK); Chui You ZHOU, Shatin (HK); Jun Jie CHU, Shatin (HK); Wan Mei HE, Shatin (HK)

(73) Assignee: JOHNSON ELECTRIC S.A., Murten (CH)

(21) Appl. No.: 13/673,580

(22) Filed: Nov. 9, 2012

(30) Foreign Application Priority Data
Nov. 11, 2011 (CN) 201110356808.X

(51) Int. Cl. H02K 1/27; H02K 7/14

(52) U.S. Cl. CPC H02K 1/276; H02K 7/145
USPC 310/50; 310/156.43

(57) ABSTRACT

An electric motor has a wound stator and a permanent magnet rotor. The rotor has a plurality of rotor core portions and a plurality of permanent magnets, the rotor core portions and the permanent magnets being arranged alternately in a circumferential direction of the rotor. The permanent magnets are made of material containing ferric oxide and polarized generally in the circumferential direction of the rotor. The motor may be used in a power tool or a lawn mower.

### CROSS REFERENCE TO RELATED APPLICATIONS

This non-provisional patent application claims priority under 35 U.S.C. §119(a) from Patent Application No. 201110356808.X filed in The People's Republic of China on Nov. 11, 2011.

### FIELD OF THE INVENTION

The present invention relates to a permanent magnet (PM) motor, and more particularly, to a permanent magnet motor for high-speed applications such as electric power tools, mowers, etc..

### BACKGROUND OF THE INVENTION

An electric power tool is a handheld or portable tool having a working head powered by a rotary type or small capacity reciprocating type motor. Electric power tools are portable, easy to operate, multifunctional, safe and reliable. By the use of electric power tools, labor intensity is decreased and working efficiency is significantly improved. Therefore, electric power tools are widely used in many applications, such as housing construction, motor vehicle construction and repair, and gardening.

It is desirable to make an electric power tool having small size, light weight and remaining large output power. That is, it is desirable to make the electric power tool having large power density and torque density. For this reason, traditional electric power tools usually use rare earth permanent magnet (REPM) motors. The rare earth permanent magnets are surface mounted (mounted on the outside surface of the rotor core). However, with the rising cost of rare earth magnets, the cost of such motors is also increasing.

Therefore, there is a need for a low cost permanent magnet motor for specific applications.

### SUMMARY OF THE INVENTION

Accordingly, in one aspect thereof, the present invention provides a permanent magnet motor comprising a stator and a rotor mounted inside the stator, the stator comprising a stator core and stator windings wound on the stator core, wherein the rotor comprises a plurality of rotor core portions and a plurality of permanent magnets, the rotor core portions and the permanent magnets being arranged alternately in a circumferential direction of the rotor; and the permanent magnets are made of material containing ferric oxide and polarized approximately in the circumferential direction of the rotor.

Preferably, the transverse cross section of the permanent magnet is in trapezoid shape, the shorter edge of the trapezoid being closer to the center of the rotor.

Preferably, the rotor comprises a shaft and a shaft sleeve fixed to the shaft; the plurality of rotor core portions are separated from each other, the radially inner end of each rotor core portion being fixed to the shaft sleeve; and each permanent magnet is fixed between two adjacent rotor core portions.

Preferably, a plurality of dovetail slots are formed in a radially outer surface of the shaft sleeve; the radially inner end of each rotor core portion is locked in a corresponding dovetail slot.

Preferably, a plurality of locating surfaces are formed on the radially outer surface of the shaft sleeve; each locating surface touches a radially inner end of the corresponding permanent magnet; and the width of the locating surface is equal to the width of the radially inner end of the corresponding permanent magnet.

Preferably, two radial locating portions are formed on two sides of the radially outer end of each rotor core portion, respectively; each radial locating portion touches a radially outer surface of a corresponding permanent magnet.

Preferably, the rotor comprises two cap members arranged at two ends of the rotor respectively and a plurality of link rods that connect the two cap members; and a through hole is formed in each rotor core portion, each through hole being passed through by one corresponding link rod.

Preferably, the link rod is a press fit within the corresponding through hole.

Alternatively, the two cap members and the link rods are molded directly to the rotor core, the cap members and the link rods forming a single monolithic structure.

Preferably, the motor has eight rotor poles and nine stator winding slots.

Preferably, the stator core comprises nine stator teeth; the stator windings form three phases of windings, each phase comprising three coils that are wound around three adjacent teeth, respectively.

According to a second aspect, the present invention provides an electric power tool, comprising a body, a handle connected to the body, and a working head at the front end of the body, wherein the body comprises a housing, a speed reduction mechanism and the permanent magnet motor defined above, the speed reduction mechanism and the motor being arranged inside the housing; and the rotary output of the motor is transmitted to the working head by the speed reduction mechanism.

According to a third aspect, the present invention provides a mower, comprising a plurality of cutting blades and an electric motor, wherein the electric motor is a permanent magnet motor as defined above, the cutting blades being rotatably driven by the motor.

The motor according to preferred embodiments of the present invention achieves the following advantages. The permanent magnets are disposed inside the rotor core, which improves the air gap flux density and makes the air gap flux density larger than the flux density at the outer surface of the magnets. Therefore, the motor has high power density and high torque density, even if the magnets are made of material containing ferric oxide. Furthermore, the rotor core is formed by a plurality of rotor core portions that are separately from each other, which eliminates the magnetic flux leakage at magnetic bridges and further improves the torque density. The torque density of the motor using ferrite permanent magnets is close to or approximately equal to the torque density of the motor using surface mounted rare earth permanent magnets.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates an electric power tool according to a preferred embodiment of the present invention;

FIG. 2 is a partial view of a permanent magnet motor according to a preferred embodiment of the present invention;

FIG. 3 is a cross sectional view of the permanent magnet motor of FIG. 2;

FIG. 4 illustrates a stator of the permanent magnet motor of FIG. 2;

FIG. 5 illustrates a longitudinal section of the permanent magnet motor of FIG. 2;

FIG. 6 is a view from below of an electric mower according to another preferred embodiment of the present invention; and

FIG. 7 is a schematic diagram illustrating the connection between the permanent magnet motor and cutting blades of the mower of FIG. 6.

### DETAILED DESCRIPTION OF THE PREFERRED EMBODIMENTS

It should be understood that an electric power tool could be an electric drill, an electric hammer, an electric planer, an electric wrench, etc. In order to simplify the description, an electric drill will be described below as an example of an electric power tool.

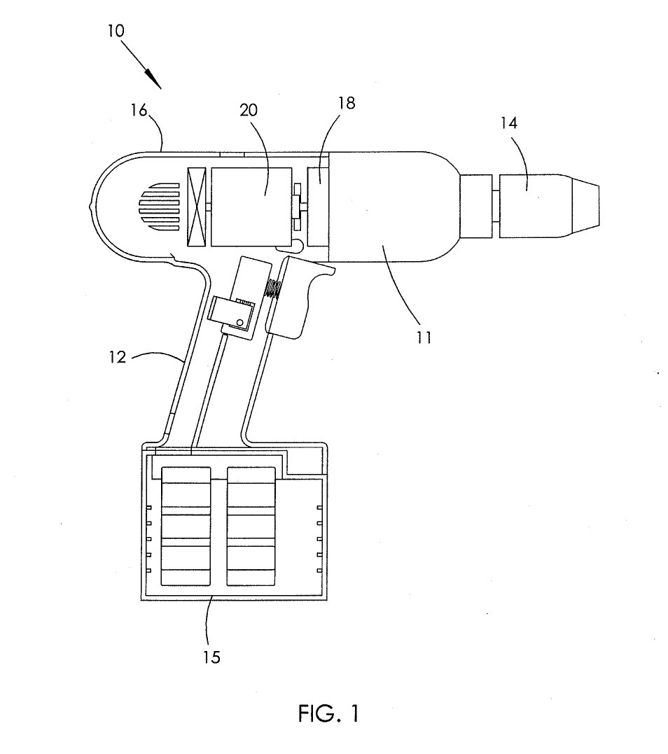

FIG. 1, illustrates an electric drill 10, with a part of the housing cut away to reveal the motor and the control switch. The electric drill 10 comprises a body 11, a handle 12 connected to the lower portion of the body 11, a working head (a drill chuck) 14 mounted on the front end of the body 11, and a battery 15 connected to a distal end of the handle. The body 11 comprises a housing 16, a motor 20 and a speed reduction mechanism 18. The motor 20 and the speed reduction mechanism 18 are accommodated in the housing 16. The rotary output of the motor 20 is transmitted to the working head 14 by the speed reduction mechanism 18.

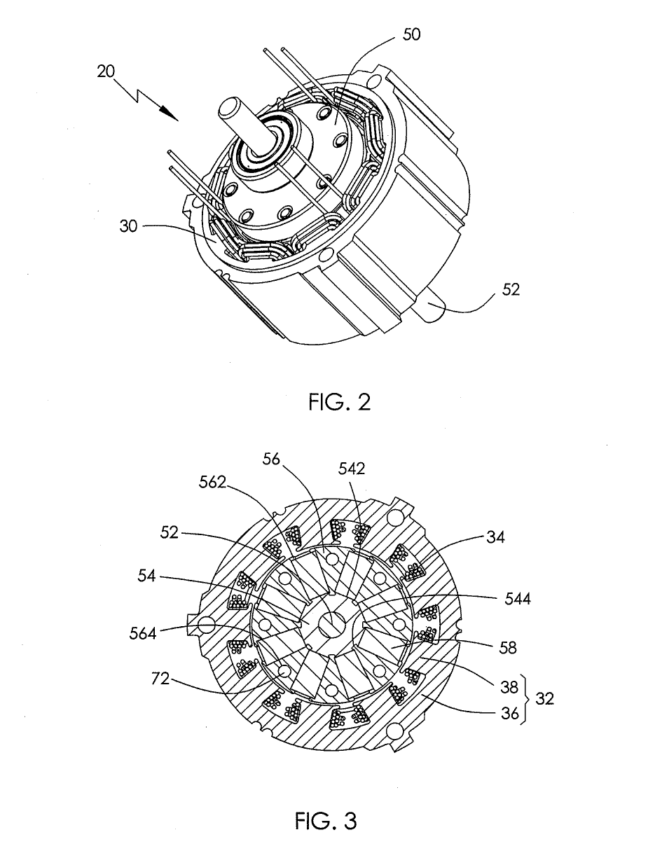

Referring to FIGS. 2 to 5, the motor 20 is a brushless permanent magnet motor, comprising a stator 30 and a rotor 50 rotatably mounted confronting the stator 30.

The stator 30 comprises a stator core 32 and stator windings 34 wound on the stator core 32. The stator core 32 comprises a ring shaped yoke portion 36 and a plurality of teeth 38 radially and inwardly extending from the yoke portion 36. Winding slots are defined between adjacent teeth 38. The stator windings 34 comprise a plurality of coils wound on the teeth 38.

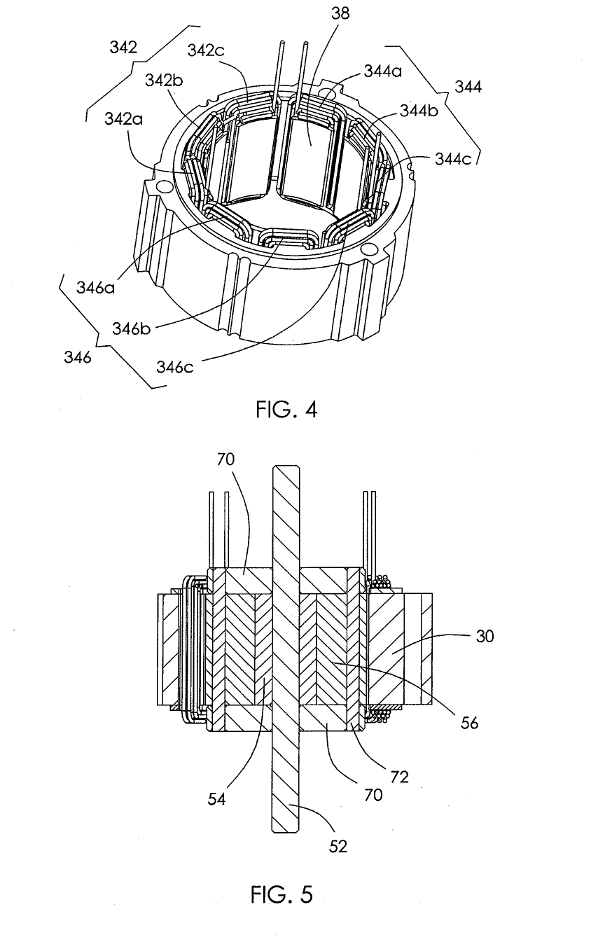

As shown in FIG. 4, in the present embodiment, the stator core 32 comprises nine teeth 38. The stator windings 34 form three phases of windings 342, 344 and 346. Each phase comprises three coils 342a-342c, 344a-344c and 346a-346c, respectively. Each of the three coils of a phase are wound on three adjacent teeth 38.

The rotor 50 comprises a shaft 52, a shaft sleeve 54 fixed to the shaft 52, a plurality of rotor core portions 56 that are separated from each other and circumferentially arranged around the shaft sleeve 54, permanent magnets 58 that are fixed between adjacent rotor core portions 56. Mounting slots are defined between adjacent rotor core portions 56. Each permanent magnet 56 is fixed into a corresponding mounting slot. Therefore, the permanent magnets 58 and the rotor core portions 56 are arranged alternately and circumferentially around the shaft 52.

Preferably, the permanent magnets 58 are made of material containing ferric oxide. The permanent magnets 58 are polarized circumferentially around the rotor shaft 52, with adjacent magnets being polarized in opposite directions.

Preferably, the transverse cross section of each permanent magnet 58 is a trapezoid shape. The shorter edge of the trapezoid is closer to the rotor center. With this configuration, the permanent magnets 58 could be as large as possible, therefore to improve the air gap flux density as well as power density.

In the present embodiment, the rotor comprises eight magnets thus to form eight rotor poles.

The shaft sleeve 54 may be over molded to the rotor shaft 52. It should be understood that the shaft sleeve 54 could be fixed to the rotor shaft 52 in other ways. A plurality of flat locating surfaces 542 are formed on the radially outer surface of the shaft sleeve 54. Dovetail slots 544 are formed between adjacent locating surfaces 542. The radially inner end of each rotor core portion 56 is also in dovetail shape and mounted/locked in a corresponding one of the dovetail slots 544. The radially inner end of each permanent magnet 58 is close to or touches a corresponding one of the locating surfaces 542. Preferably, the width of the flat locating surface 542 is equal to the width of the radially inner end of the permanent magnet 58.

At the radially outer end of each rotor core portion 56, two radial locating portions 562 are formed. The two radial locating portions 562 extend circumferentially and in opposition directions, respectively. Each radial locating portion 562 touches a radially outer surface of a corresponding permanent magnet 58. In this configuration, the radially outer surface of each permanent magnet 58 touches two radial locating portions 562, one from each of two adjacent rotor core portions 56. Therefore, the permanent magnets 58 are fixed in the radial direction.

The rotor 50 further comprises two cap members 70 arranged at two ends of the rotor 50 and a plurality of link rods 72 each of which connects to the two cap members 70. Each link rod 72 passes through a corresponding rotor core portion 56. Preferably, a through hole 564 is formed in each rotor core portion 56. Each link rod 72 tightly passes through one corresponding through hole 564. Preferably, the link rods 72 are a press fit with the through holes in the rotor core portion 56. Each link rod 72 is also a press fit with the two cap members 70. It should be understood that the link rods 72 may be fixed to the rotor core portions 56 and the cap members 70 in other ways. For example, the link rods 72 may be molded to the rotor core portions 56 and the cap members 70.

The motor used in electric power tools usually has a small size and a small outer diameter. Therefore, there should not be too many winding slots. Otherwise, the space utilization ratio of the winding slots will decrease, which results in low power density and low torque density, and makes it more difficult to manufacture.

To improve the power density, electric power tools usually use a high-speed motor (close to 20,000 Revolutions Per Minute). Therefore, there should not be too many poles. Otherwise, the iron loss of the motor would be too much and the efficiency will decrease. However, for a motor with permanent magnets inserted into rotor core, if the number of rotor poles is too small, the poly magnetic effect is not so good.

In the present embodiment, the motor applying the configuration of eight poles and nine winding slots. Specifically, the rotor has eight magnetic poles and the stator has nine winding slots/teeth. With this kind of configuration, the motor has the advantage of high winding coefficient and high winding utilization, which improves the torque density and efficiency, and lowers the cogging torque of the permanent magnet motor. Furthermore, for the eight-pole nine-slot motor, the three coils of each phase may be adjacently arranged, which is helpful in the winding process and in mass production.

The motor according to the present invention may be used in other applications, and more particularly, in the applications that requires a high-speed motor. For example, the motor according to the present invention may be used in a lawn mower.

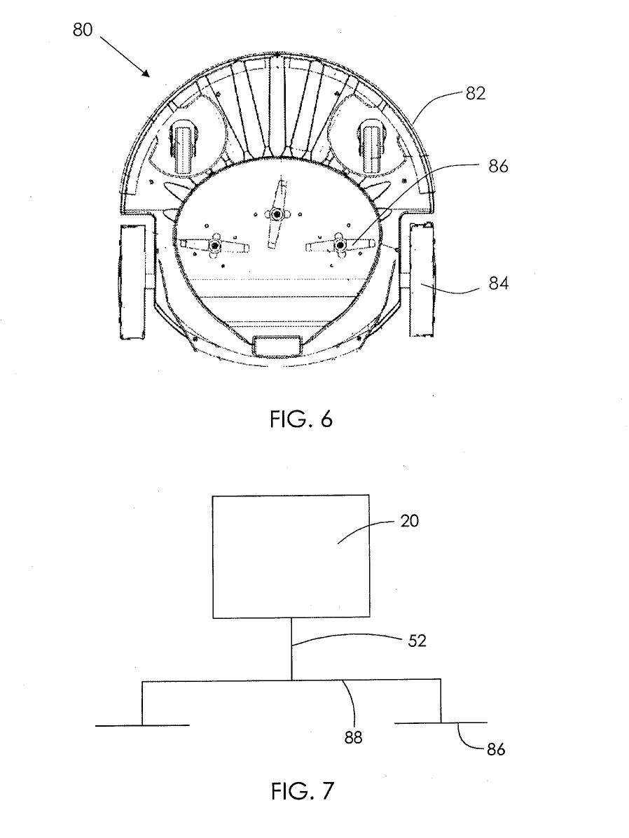

FIG. 6 and FIG. 7 illustrate a mower 80 in the form of a robot lawn mower. FIG. 6 is a view of the mower from below showing the wheels and cutting blades. The mower 80 comprises: a body 82, a plurality of wheels 84 connected to the body 82, and a plurality of cutting blades 86. As shown in the simplified, schematic diagram of FIG. 7, the motor 20 drives the cutting blades 86 through a connecting mechanism 88. The motor 20 is mounted to the body 82. The cutting blades 86 been rotatably driven by the connecting mechanism 88, and the connecting mechanism 88 is driven by the shaft 52 of the motor 20.

The embodiments were chosen and described in order to explain the principles of the invention and their practical application to enable others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present invention is defined by the appended claims rather than the foregoing description and the exemplary embodiments described therein.

In the description and claims of the present application, each of the verbs “comprise”, “include”, “contain” and “have”, and variations thereof, are used in an inclusive sense, to specify the presence of the stated item but not to exclude the presence of additional items.

1. A permanent magnet motor comprising a stator and a rotor mounted inside the stator, the stator comprising a stator core and stator windings wound on the stator core,
wherein the rotor comprises a plurality of rotor core portions and a plurality of permanent magnets, the rotor core portions and the permanent magnets being arranged alternately in a circumferential direction of the rotor; and
the permanent magnets are made of material containing ferric oxide and polarized approximately in the circumferential direction of the rotor.

2. The permanent magnet motor of claim 1, wherein the transverse cross section of the permanent magnet is in trapezoid shape, the shorter edge of the trapezoid being closer to the center of the rotor.

3. The permanent magnet motor of claim 1, wherein the rotor comprises a shaft and a shaft sleeve fixed to the shaft;
the plurality of rotor core portions are separated from each other, the radially inner end of each rotor core portion being fixed to the shaft sleeve; and
each permanent magnet is fixed between two adjacent rotor core portions.

4. The permanent magnet motor of claim 3, wherein a plurality of dovetail slots are formed in a radially outer surface of the shaft sleeve;
the radially inner end of each rotor core portion is locked in a corresponding dovetail slot.

5. The permanent magnet motor of claim 4, wherein a plurality of locating surfaces are formed on the radially outer surface of the shaft sleeve;
each locating surface touches a radially inner end of the corresponding permanent magnet; and
the width of the locating surface is equal to the width of the radially inner end of the corresponding permanent magnet.

6. The permanent magnet motor of claim 1, wherein two radial locating portions are formed on two sides of the radially outer end of each rotor core portion, respectively;
each radial locating portion touches a radially outer surface of a corresponding permanent magnet.

7. The permanent magnet motor of claim 3, wherein the rotor comprises two cap members arranged at two ends of the rotor respectively and a plurality of link rods that connect the two cap members; and
a through hole is formed in each rotor core portion, each through hole being passed through by one corresponding link rod.

8. The permanent magnet motor of claim 7, wherein the link rod is a press fit within the corresponding through hole.

9. The permanent magnet motor of claim 7, wherein the two cap members and the link rods are molded directly to the rotor core, the cap members and the link rods forming a single monolithic structure.

10. The permanent magnet motor of claim 1, wherein the motor has eight rotor poles and nine stator winding slots.

11. The permanent magnet motor of claim 10, wherein
the stator core comprises nine stator teeth;
the stator windings form three phases of windings, each phase comprising three coils that are wound around three adjacent teeth, respectively.

12. An electric power tool, comprising a body, a handle connected to the body, and a working head at the front end of the body, wherein the body comprises a housing, a speed reduction mechanism and the permanent magnet motor of claim 1, the speed reduction mechanism and the motor being arranged inside the housing; and
the rotary output of the motor is transmitted to the working head by the speed reduction mechanism.

13. A mower, comprising a plurality of cutting blades, wherein the mower further comprises the permanent magnet motor of claim 1, the cutting blades being rotatably driven by the motor.
